(19) United States
(12) Patent Application Publication
(10) Pub. No.: US 2010/0192868 A1
(43) Pub. Date: Aug. 5, 2010

(54) Submersible Farm

(76) Inventors: Andres Quinta Cortiñas, Pontevedra (ES); Eladio Diaz Arbones, Pontevedra (ES)

Correspondence Address: BREINER & BREINER, L.L.C., P.O. BOX 320160, ALEXANDRIA, VA, 22320-0160, US

(21) Appl. No.: 11/991,741

(22) PCT Filed: Sep. 8, 2006
(86) PCT No.: PCT/ES2006/070133

§ 371 Date: Mar. 10, 2008

(30) Foreign Application Priority Data
Sep. 12, 2005 (ES) P200502211

(51) Int. Cl. A01K 61/00

(52) U.S. Cl. 119/208

(57) ABSTRACT

A submersible farm is described including a self-supporting frame which can be submerged and maintained at a selected depth. The submersible farm further includes a first radial structure having lattice-forming beams which are placed edgeways in order to support a second structure which bears culture ropes and is disposed horizontally below the first structure. The first structure includes a float which extends partially along the periphery thereof and which includes at least a peripheral inlet and outlet for the culture ropes leading to a berth. The berth is fixed to the first radial structure. The frame is supported by a counterweighted flotation column which is disposed at the center of both the first and second structures and which includes a float which extends downward into a counterweighted tube having a stabilizing system suspended therefrom.

### TECHNICAL SCOPE

This invention relates to a submersible shellfish farm that can be anchored to the seabed and kept at a specific depth between the surface and the seabed and raised through the use of floats and hoisting elements, intended especially but not exclusively for breeding mussels or other molluscs in the open sea and to assist support and labour from the surface.

### BACKGROUND OF THE INVENTION

In rough waters there is a larger quantity of nutrients and the possibility of changing the depth of the farm results in greater and quicker growth of the molluscs attached to the culture ropes that can be moved in the water. Therefore it is desirable to place these farms in this type of water or in close proximity thereof.

In that sense, in the document ES U0273021 by Piñeiro, a submersible farm is described for marine cultures comprising a horizontal structure with a structure from which the culture ropes are suspended with conveniently positioned hoses to make closed circuits to be filled with water when it is necessary to submerge the farm with vertical frames that are also tubular fitted to the sides that comprise a surface float for the farm. Nevertheless, in rough water, and in spite of the farm being loosely anchored, it is the culture ropes that bear the brusque movements of the waves and the immersions or ermersions of the submersible farm thereby giving rise to the detachment of the crop and consequent losses in production. Access to the central culture ropes in the farm is also laborious and complex. The increase in weight of the production can drag the farm and the load to the seabed if they are not suitably controlled.

In document GB 2302525 by Burgess, a submersible platform is described for breeding shellfish which comprises a structure that has one or more rising, adjustable chambers and which is adapted to be submerged to a chosen depth and kept in that position through the use of the said chamber or chambers that can be located on the surface and connected to the platform via an external, flexible connection. The invention itself has a substantially circular structure with a perimeter float with enough capacity to keep the structure floating along with a central nucleus. Between the central nucleus and the float, spokes extend between which breeding trays or culture ropes are supported. An adjustable, rising chamber is positioned in the centre of the platform crowned with a fixed mast that contains a water regenerator that enriches the water with nutrients.

In ES 200401977 by Quinta and Diaz, a farm is described comprising a self-supporting frame consisting of a floating structure in an “H” shape. It is made from tubular elements containing air for the weighted floats at the ends of the frame which can be anchored to the seabed and submerged, raised or kept in a chosen position through the use of floats and lifting elements. The frame is guided during vertical movements by a surface buoy comprising a main floating body and a descending guide tube that passes through the frame and includes a lower depth stop that limits downward movement and includes pulleys and lifting cables between the frame and the dead weights. The structure includes beams with side joists to support the culture ropes and guides for the product collection carts.

In the farms described, the supports for the growing stock are precarious. The collection of the ropes is laborious and slow and much detachment is observed of the molluscs attached to the culture ropes due to the brusque movements involved in extracting the ropes.

### PURPOSE OF THE INVENTION

According to what has gone before, it is desirable to design a submersible farm that is immediately adaptable, while at the same time avoiding brusque movements, to convenient working positions so that the molluscs remain firmly attached to the culture ropes and so that they are able to open their valves without difficulty to receive and eliminate nutrients, thereby giving rise to quick growth and support.

One purpose of the invention is to ensure suitable support of the carrying structure of the culture ropes together with the load and the growth thereof for which a radial structure has been designed made from reticular beams in lattice formation on edge to support the carrying structure of the culture ropes. On the support of the farm and the crop a counterweighted flotation column is included fitted centrally under both structures which, at least in one part thereof will be crossed by the surface buoy that guides the farm during vertical movement.

Another purpose of the invention is to try to carry out the work on the farm in an effective way with low production losses. For this purpose the support structure has been designed with at least one opening in the perimeter to gain access to a berth point to allow gentle handling and loading of the moored vessel without disturbing the inner and outer culture ropes thereby preventing notable detaching of the molluscs.

### Description of the Invention

According to the invention the improved submersible farm comprising a self-supporting frame that can be anchored to the seabed and submerged, while keeping it at a chosen depth and being able to raise it to the surface using floats and traction elements. Further, the self-supporting frame can be guided during vertical movement by a surface buoy comprising a main float and a descending guide tube that vertically crosses the frame and that has a maximum depth stop that limits its movement.

Substantially, the frame comprises a first radial structure made from reticular beams in lattice formation arranged edgeways to support a second structure that carries the culture ropes that are horizontally arranged under the first structure. Said first structure is fitted with a float that does not cover the whole perimeter at least one perimeter opening on the outer edge of the structure that provide an exit for radial passes between the inside and the outside of the structure allowing for entry and exit of the culture ropes towards a fixed berth point at one of the openings at least and more specifically fixed to both sides thereof.

The aforementioned perimeter float is substantially arranged under both the first and second structures in order to enable work and maintenance of the farm and is designed with the lifting capacity to cope with the weight of the empty frame. The perimeter float is designed with one or more floats that can be regulated either together or separately in order to apply an adjustable upwards force.

In the event of the perimeter float comprising several floats, said floats will also be able to be individually controlled and separate from each other thereby maintaining the perimeter line with the purpose of each separation comprising a perimeter opening which will coincide with the radial layout of each of the beams carrying the culture ropes and with the purpose of enabling the work of entry and exit of the culture ropes without disturbing the others.

Furthermore, it will contribute to the support of the self-supporting flotation column, counterweighted to reduce the centre of gravity of the farm and to reinforce balance keeping and stability, arranged underneath centrally regarding the aforementioned first and second structures and comprising a main float fitted under the frame and joined at least to the first structure.

The main float comprises a ballast tank and a sealed pressure tank with a central pass that that will be vertically upwards through the use of a short guide tube that will stand out above the farm. It will follow a guided slide in the descending tube from the float of the buoy on the surface that it crosses, by the effects of the tides or the weight of the crop as it increases. For better retaining and sliding of the frame, the descending guide tube with two types of sliding movement, upwards and downwards being fixed or at least adjustable on the lower end of the tube and on the upper end coinciding with the base of the main float of the buoy or next to it, and also movable along the length of the tube.

The main float also extends underneath through a lengthways tube chosen in accordance with the roughness of the water in the place chosen to place the farm, which comprises a counterweighted mass contained on the lower extreme or on the frame and which is welded or screwed to the extreme, and from which a stabilising system hangs for the farm where the pulleys, traction cable, cable dead weight and when applicable mobile counterweights are positioned.

The farm is designed with level sensors in the floats and beacon buoy that detect the tilt of the frame and transmit them to a programmable automatic system that automatically controls and corrects the flotation level by activating the electro-valves that inject or empty air from the system. The processes and movements of the farm can be controlled remotely with a cellular telephone controller, for example GSM, or, if required, this control can be blocked so as to allow onboard control through an automatic electronic system.

### DESCRIPTION OF THE DRAWINGS

As an example, the drawing herewith attached shows the preferable workings of the improved submersible farm according to the invention. In a schematic way

FIG. 1 illustrates a view plan of the improved submersible farm.

FIG. 2 illustrates an elevation of the improved submersible farm without the berth.

### PREFERENTIAL EMBODIMENT OF THE INVENTION

In accordance with the proposed example of the embodiment, the improved submersible farm includes a self-supporting frame (1) that comprises a first radial structure (2), with reticular beams in lattice form (3) arranged edgeways to support a second structure (4) that in the example comprises radial beams (5) that hold the culture ropes (28) and horizontally arranged under the first structure (2).

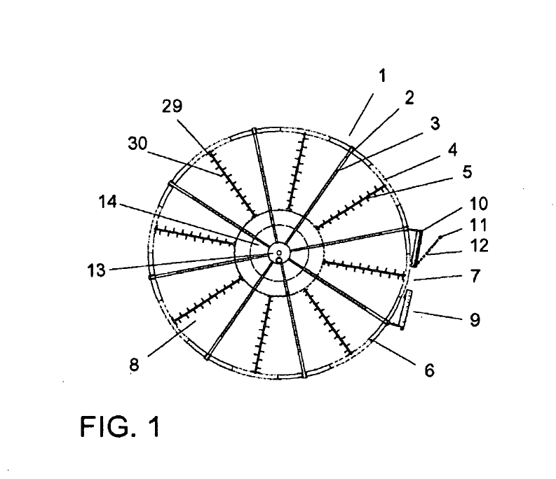

As can be seen better in FIG. 1, the outer perimeter of the first radial structure (2) is bordered by a perimeter float (6) comprising an open tubular ring, in the proposed example, with perimeter openings (7) that provide an exit for radial passes (8) between the inside and outside of the structure (2) for obstacle free movement of the culture ropes (28) carried on the radial beams (5) opposite the relevant openings (7) when control or maintenance of entry and exit to the farm is required. In figure, the continuity of the perimeter of the ring float (6) is shown through a drawn line and a dot.

For better flotation control the tubular, ring (6) is supported and connected to the main float in the centre of the structure by the reticular beams (3) and divided into flooded, watertight zones that can be independent from each other, although to ensure equal pressure, or to avoid and correct possible undesirable heeling a common distributor is fitted and sections of pneumatic hose (not shown) connected to each of the individual zones of the auxiliary float arranged on the farm or in the surrounding area, for example in an auxiliary vessel.

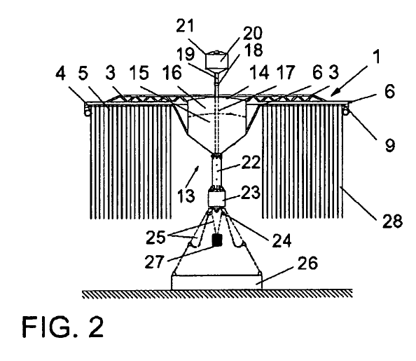

As can be better seen in FIG. 2, the tubular ring (6) substantially passes under the perimeter of the first structure (2) and the lines and dot that define it are interrupted on both sides of one of the openings (7) where the berth has been fitted (9) for vessels with gangplanks from which to work (10), fenders (11) for the berth and devices (12) to automatically keep the vessel distanced from the farm.

The self-supporting frame (1) is supported centrally by a flotation column (13) comprising, according to the example, a main cylindrical float (14) with compartments with a ballast tank (15) and a pressure tank (16). The float (14) has a central pass (17) that extends vertically upwards through a short guide tube (18) that stands out above the frame (1) and between both the descending tube (19) is fitted to the flotation body (20) of the surface buoy (21) that crosses the frame (1). The lower base of the float (14) is joined via a tube (22) to the counterweight (23) on the base of which the pulleys (24) are located that support the lifting cables (25) from which the dead weights hang (26) for anchoring the farm to the seabed and the auxiliary mobile counterweights (27).

In order to facilitate maintenance and work on the frame (4), on the sides of the beams (5) supporting the labour ropes (28) there are incorporated grate gangplanks. In the beams (5) there are some transversal extensions that describe arms (30) from which the ropes (28) hang and whose length and separation distances are designed to favour the supply of nutrients to the crop as the sea currents pass through. Between the arms (30) on the same side as the beams (5) it is possible to hang a cable or fibre bar that acts as a support for the ropes while they await collection and as a guide for the transport cart that transports them to the outside of the farm (1).

1. (canceled)

2. (canceled)

3. A submersible farm comprising
(a) a self-supporting frame, wherein the frame is constructed and arranged to be submerged and anchored to a seabed, maintained at a predetermined depth and raised by floats and lifting elements, and wherein the self-supporting frame further includes a surface buoy constructed and arranged to guide said frame during vertical movement, wherein said surface buoy comprises a floating body with a descending guide tube that vertically crosses the frame and is fitted with a depth stop that limits maximum vertical movement, and
(b) a first radial structure comprising reticular beams in lattice formation arranged edgeways to support a second structure that supports culture ropes positioned horizontally under the first radial structure, and fitted to said first structure, a float that partially extends around a perimeter of said first structure so as to provide at least one perimeter inlet for entry and exit without disturbing the culture ropes leading to a berth fixed to the first radial structure.

4. The submersible farm according to claim 3, wherein said self-supporting frame further comprises, in support of said frame, a counterweighted flotation column bottom centered in relation to the first radial structure and said second structure and comprising at least one main float positioned under said first radial structure that extends downward through a tube of a length that extends onto a counterweight from which a stabilizing system hangs, said stabilizing system including pulleys, lifting cables and concrete ballast, and wherein said flotation column or said at least one main float is vertically crossed by said one tube.
